(19) United States
(12) Patent Application Publication
(10) Pub. No.: US 2004/0109602 A1
(43) Pub. Date: Jun. 10, 2004

(54) Method and apparatus for inspecting a bump electrode

(76) Inventors: Yusuke Konno, Futtsu-shi (JP); Taro Kohno, Futtsu-shi (JP)

Correspondence Address: BIRCH STEWART KOLASCH & BIRCH, PO BOX 747, FALLS CHURCH, VA, 22040-0747, US

(21) Appl. No.: 10/716,610

(22) Filed: Nov. 20, 2003

(30) Foreign Application Priority Data
Nov. 22, 2002 (JP) JP2002-338852

(51) Int. Cl. G06K 9/00

(52) U.S. Cl. 382/150

(57) ABSTRACT

A method and apparatus for inspecting a bump electrode is almost independent of a surface condition of an object to be inspected. Before starting inspection, a template image is prepared by using a predetermined function. During inspection, a gradation correction of the photographed image is made by using a function with a saturation characteristic. The photographed image, which includes an image corresponding to at least one ball, is then segmented. Whether each bump electrode is an acceptable product or not is determined by pattern matching by calculating a normalized correlation coefficient between the segmented image and the template image prepared in advance.

### CROSS-REFERENCE TO RELATED APPLICATIONS

This nonprovisional application claims priority under 35 U.S.C. § 119(a) on Patent Application No. 2002-338852, filed in Japan on Nov. 22, 2002, the entirety of which is incorporated herein by reference.

### BACKGROUND OF THE INVENTION

1. Field of the Invention

The present invention relates to a method for inspecting a bump electrode including a micro solder ball (hereinafter referred to as a ball) used as a bump electrode of a semiconductor element such as an LSI. The inspection can be performed before and/or after the micro solder ball is heated to be soldered onto a substrate. A micro solder ball, even if it is a single ball, is referred to as a bump electrode after being heated and soldered on a substrate. The term micro solder ball typically means a ball having a diameter ranging from 70 to 700 μm. However, it should be understood that the term micro solder ball should not be limited to this diameter.

2. Description of Background Art

Some inspection methods have been used in the field. For example, a method is known in the background art for identifying a defective ball by determining a difference between the image of an object to be inspected and a master image, which is made by averaging many images of acceptable products that meet a predetermined quality standard. In addition, a method is known in the background art for digital image processing such as labeling after binarizing the image of an object to be inspected. A method is also known in the background art for pattern matching based on a normalized correlation coefficient by segmenting each image of a ball to be inspected.

The above methods according to the background art are based on the premise that a luminance distribution of the image of an acceptable product does not greatly change. However, since a bump electrode, i.e., an object-to-be-inspected of the invention, has changes in color and/or in surface roughness, a luminance distribution of the image changes greatly even if the bump electrode is an acceptable product. Therefore, the above methods according to the background art have a risk in that an acceptable product can be erroneously determined as a non-acceptable product with some defects.

The deformation of a ball, a missing ball or an incorrect ball size are different kinds of defects to be inspected. Since an incorrect size ball can cause an improper connection at mounting, it is important to determine the size of the ball as well as other items to be inspected. If the presence of a small ball is to be determined by using pattern matching based on a single template image, the determination is more difficult compared to the determination of a missing ball because a luminance distribution of an acceptable product and that of a small ball are fairly the same. In addition, as mentioned above, averaging a large number of images of acceptable products makes a template image. Accordingly, making a template image is a very time-consuming process.

### SUMMARY OF THE INVENTION

In view of the above, an object of the present invention is to provide a method and apparatus for inspecting a bump electrode, which is almost independent of the surface condition of an object to be inspected.

In order to accomplish this object, a method for inspecting a bump electrode according to a first aspect of the present invention comprises the steps of:

illuminating a substrate in an oblique direction where balls are arrayed by using an annular type illumination device;

photographing the substrate from above the substrate;

correcting a gradation of the photographed image of an annular pattern by using a function with a saturation characteristic;

making a segmented image which includes an image corresponding to at least one ball; and

determining whether each bump electrode is an acceptable product or not by pattern matching by calculating a normalized correlation coefficient between the segmented image and a template image prepared in advance.

In a method according to a second aspect of the present invention, the template image for pattern matching is prepared by using a mathematical formula model representing a luminance distribution.

In a method according to a third aspect of the present invention, the step of determining further includes the step of pattern matching by calculating a plurality of normalized correlation coefficients between the segmented image and a plurality of template images corresponding to sizes of a bump electrode to be inspected so that the size of the bump electrode can be determined.

In addition, in order to accomplish the object of the present invention, an apparatus for inspecting a bump electrode according to a fourth aspect of the present invention comprises:

an illumination device, said illumination device illuminating a substrate in an oblique direction where balls are arrayed;

an image pick-up device, said image pick-up device photographing the substrate from above the substrate;

an image processing device, said image processing device correcting a gradation of the photographed image of an annular pattern by using a function with a saturation characteristic, making a segmented image which includes an image corresponding to at least one ball and determining whether each bump electrode is an acceptable product or not by pattern matching by calculating a normalized correlation coefficient between the segmented image and a template image prepared in advance.

In an apparatus according to a fifth aspect of the present invention, the template image for pattern matching is prepared by using a mathematical formula model representing a luminance distribution.

In an apparatus according to a sixth aspect of the present invention, the pattern matching is performed by calculating a plurality of normalized correlation coefficients between the segmented image and a plurality of template images corresponding to sizes of a bump electrode to be inspected so that the size of the bump electrode can be determined.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic block diagram showing an apparatus for inspecting a bump electrode according to one embodiment of the present invention;

FIG. 2A is an explanatory diagram of a photographed image of an annular pattern;

FIG. 2B is a photograph of one example of annular patterns of a photographed image;

FIG. 2C is a photograph of a template image with a single annular pattern;

FIG. 3A is an explanatory diagram of preparing a template image;

FIG. 3B is a photograph of a template image with four annular patterns;

FIG. 4 is a processing flow chart showing an example of the present invention;

FIG. 5 is an explanatory diagram of a function having a saturation characteristic for gradation correction; and

FIG. 6 is a flow chart for an example of a ball size determination.

### DETAILED DESCRIPTION OF THE PREFERRED EMBODIMENTS

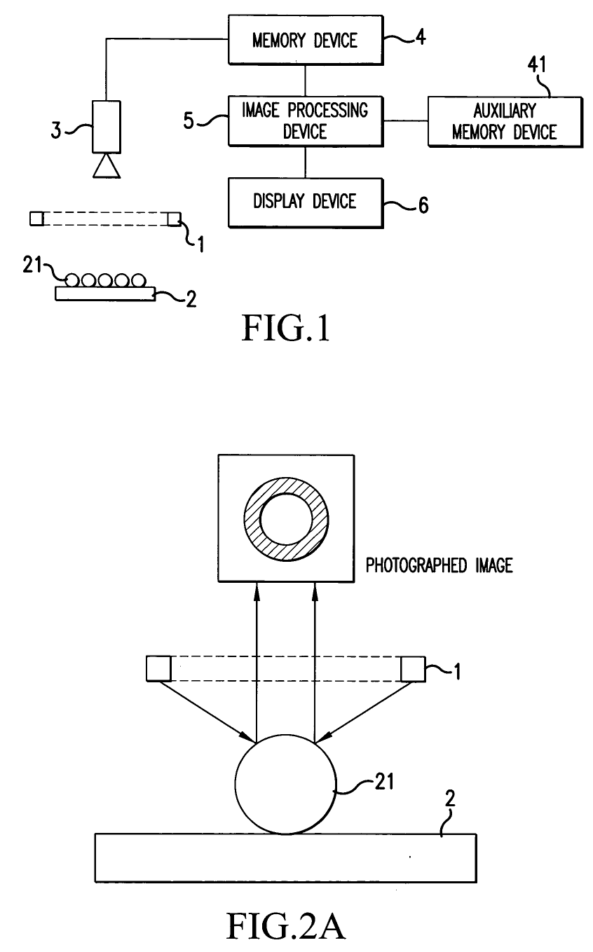

FIG. 1 is a schematic diagram showing an apparatus for inspecting a bump electrode according to one embodiment of the present invention. An illumination device 1 is an annular type illumination device, which illuminates a substrate 2 in an oblique direction where balls 21 are arrayed. An image pick-up device 3 including a CCD camera photographs the substrate from directly above the substrate. A memory device 4 is a frame memory, which stores the photographed image. An auxiliary memory device 41, such as a hard disk, stores template images. An image processing device 5 is provided for processing and making a determination with respect to an input image. A display device 6 is for displaying a processed result and the input image.

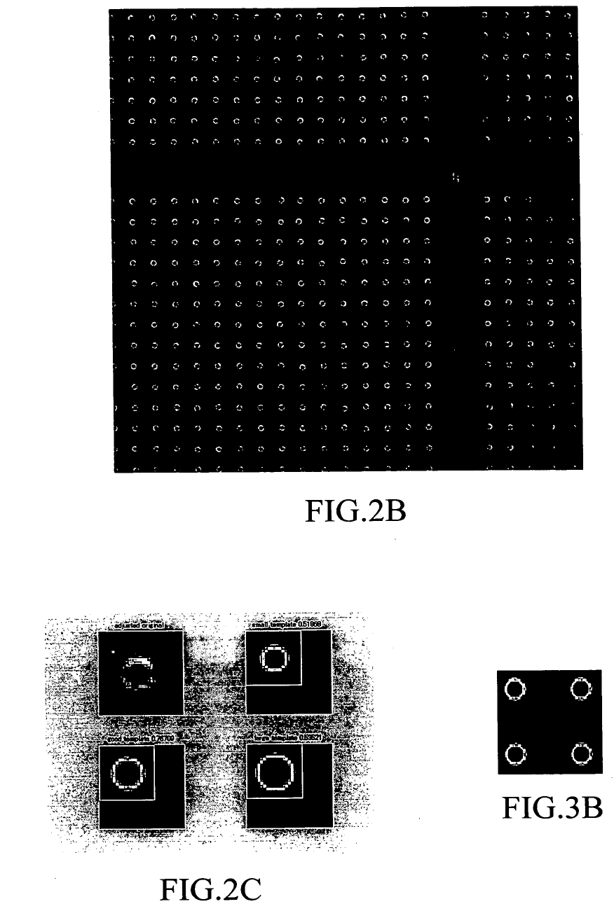

The ball 21 is illuminated in an oblique direction by the illumination device. Accordingly, the image pick-up device 3 mainly receives regular reflected light. The regular reflected light is photographed as an annular image as shown in FIG. 2A and is stored in the memory device 4 as a digital image. A photograph of one example of annular patterns of a photographed image is illustrated in FIG. 2B. Usually, a luminance value of an image is digitized as an integer of 8 bits ranging from 0 to 255. In view of this, it is assumed in the following explanation that the luminance value of an image ranges from 0 to 255.

In order to carry out the present invention, a template image has to be prepared before starting the inspection. A photograph of a template image with a single annular pattern is illustrated in FIG. 2C. The template image is prepared based on the below formula (1) using the parameters of a radius r of an annular pattern and a thickness d of the annular pattern.

I(R, r, d)=255×exp{−(R−r/d)²} (1),

where I is a luminance value (0-255) of a point specified by R in a template image; R is a distance from a center of the template image to an arbitrary point on the template image; r is a parameter for determining a radius of an annular pattern; and d is a parameter for determining a thickness of an annular pattern.

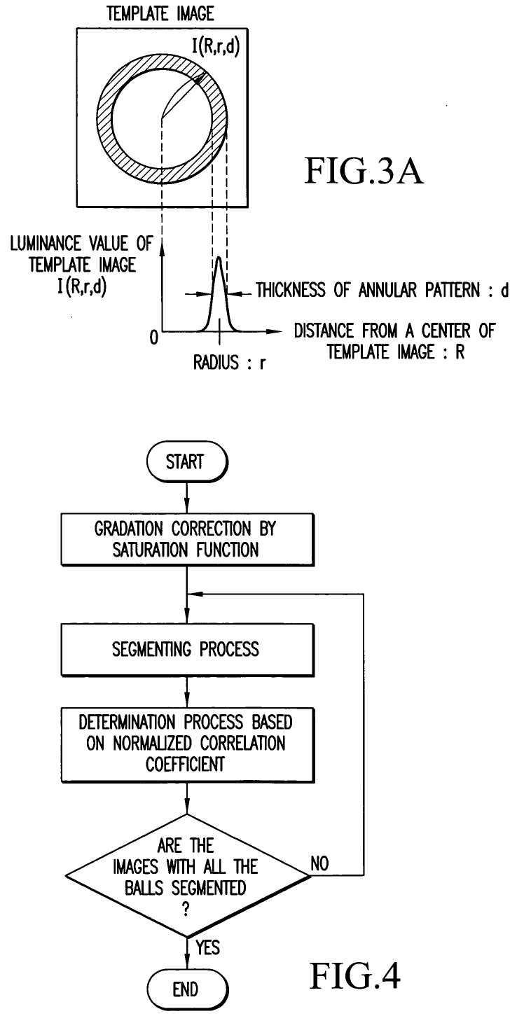

The above formula (1) is a function of only R. Accordingly, a prepared image becomes annular and a radius of the annular pattern where a maximum luminance value is given is equal to the parameter r. An example of a template image prepared by formula (1) is shown in FIG. 3A. In FIG. 3A, a template image is shown at an upper part of the drawing and a variation of a luminance value according to the distance from a center of the template image is shown at a lower part of the drawing. A size of the template image has to be larger than that of the photographed annular pattern. However, an unnecessarily large size of the template image merely increases the amount of calculation necessary for pattern matching. In view of this, the size of the template image should preferably be 1.2-1.5 times the size of the annular pattern. It should be noted that the formula (1) does not always have to be used for preparing the template image. For example, a function that has a value in the vicinity of the radius r of the annular pattern and a value of zero away from the vicinity of the of the radius r of the annular pattern can be used instead of the formula (1). The template image can include a plurality of annular patterns corresponding to a plurality of balls, e.g., two to four (see FIG. 3B), which are arrayed side by side and/or diagonally. This enables an increase in the number of balls being compared at one time, which leads to a reduction of inspection time.

A single template image corresponding to an acceptable product is required in order to determine if there is a deformed ball and/or a missing ball. However, in order to determine the size of the ball, three kinds of template images should be prepared. The three kinds of template images should correspond to a large size ball (larger than an acceptable ball product), an acceptable size ball, and a small size ball (smaller than an acceptable ball product), respectively. The three kinds of templates are prepared by changing the parameters r and d defining the radius and thickness of the annular pattern, respectively. The template images are kept in the auxiliary memory device 41 to be used during inspection.

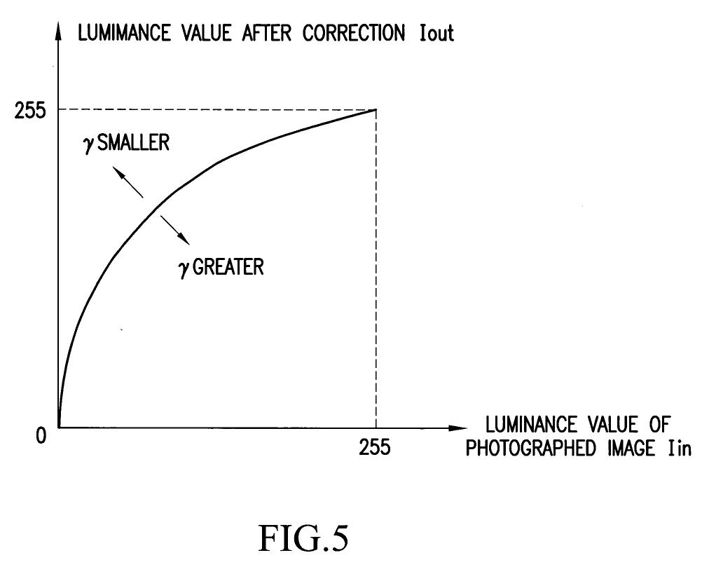

During inspection, a photographed image by an image pick-up device is stored in the memory device 4 and then a determining process occurs in the image processing device 5. A processing flow performed in the image processing device 5 is shown in FIG. 4. First, a gradation correction of an image is performed in the image processing device 5 according to a function having input-output characteristics shown in formula (2) below. FIG. 5 shows the input-output relationship of the formula (2) function.

Iₒᵤₜ=255×(Iᵢₙ/255)^{γ} (2),

where Iᵢₙ is the luminance value of the photographed image (0-255); Iₒᵤₜ is the luminance value after gradation correction (0-255); and γ is the parameter for adjusting the saturation characteristic (0<γ<1).

In the present invention, γ can have a value between 0 and 1, but is typically set at 0.5. The primary ingredient of the ball is solder. Therefore, the surface of the ball is almost a mirror surface, which causes a change of a surface condition of the ball to be converted into a reduction in brightness of the annular pattern. However, the gradation correction corrects the reduction in brightness (dark part of the image) of the annular pattern. Accordingly, in the situation where the annular pattern of the photographed image lacks some portion because of partial darkness of the ball surface, the lacked portion is corrected more than other portions which are originally bright because of the saturation characteristic. Consequently, the gradation correction enables a pattern of the photographed image to become closer to the annular pattern. The gradation correction can increase a value of the normalized correlation coefficient at a determination step described below. Such an effect cannot be obtained by adding a value to the luminance value of the photographed image or by multiplying the luminance value of the photographed image by a constant to enhance the contrast. In view of this, a function with a saturation characteristic is used in the present invention. In addition to the formula (2), a polygonal line function can be used as one function having a saturation characteristic.

Many annular patterns corresponding to balls are arrayed in the image on which gradation correction has been made. In the segmenting step, a segmented image including at least one annular pattern corresponding to one ball is prepared from the image in the situation where the ball is positioned at a predetermined place on the substrate and then the following determination step is applied to the segmented image. The size of the segmented image should be equal to or larger than the size of the template image.

In the determination step, a normalized correlation coefficient is calculated to obtain the maximum value thereof while shifting the template image with respect to the segmented image. The normalized correlation coefficient is used as a standard pattern matching method. With respect to the segmented ball image, when the annular pattern of the segmented image exactly matches that of the template image, the normalized correlation coefficient becomes a maximum, i.e., almost 1 (one). In contrast, a segmented image of a deformed ball or missing ball has a totally different luminance distribution pattern from that of the template image. Consequently, the normalized correlation coefficient does not have a distinct peak and even the maximum value is almost 0 (zero). In view of this, in the case of determining if there is a deformed ball, a missing ball, or a misaligned ball, an inspected product can be determined as an acceptable product if the value of the normalized correlation coefficient is larger than a threshold value, where the coefficient is determined by using a single template image corresponding to an acceptable product.

When the size of the segmented image is large, the number of calculations for obtaining the normalized correlation coefficient increases. However, an allowable value for misalignment of a ball increases. If the size of the segmented image is small, for example, the same as the size of the template image, a single calculation is required to obtain a value of the normalized correlation coefficient. However, an allowable value for misalignment of the ball becomes very small. In view of this, the size of the segmented image should be determined according to a required allowable value for ball misalignment.

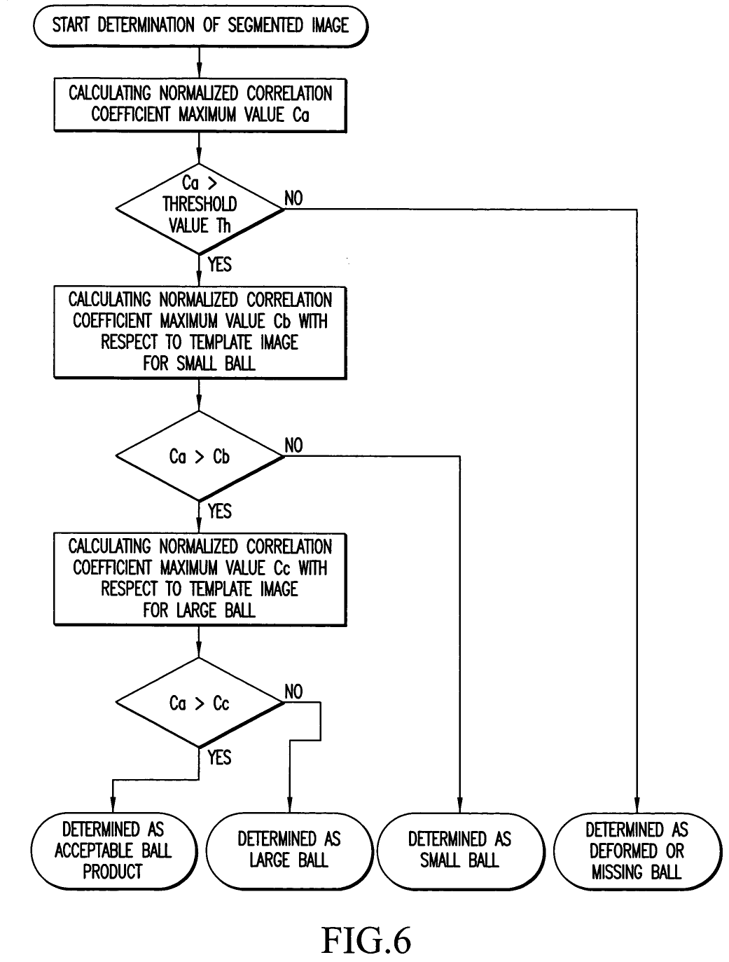

In order to determine the size of the ball, three maximum values of the normalized correlation coefficient are calculated with respect to three kinds of templates, which correspond to a large size ball (larger than an acceptable ball product), an acceptable size ball, and a small size ball (smaller than an acceptable ball product), respectively. The size determination is then made based on the values of the normalized correlation coefficient. For example, the flow chart shown in FIG. 6 can be used for the determination. In FIG. 6, first, a normalized correlation coefficient maximum value Ca is calculated with respect to the template image for an acceptable product. If Ca is equal to or less than a threshold value Th, a deformed ball or a missing ball is determined as being present. If Ca is greater than Th, Ca and a normalized correlation coefficient maximum value Cb, which is obtained by calculating with respect to the template image for the small size ball, are compared to each other. If Cb is equal to or greater than Ca, a small ball is determined as being present. If Cb is less than Ca, Ca and a normalized correlation coefficient maximum value Cc, which is obtained with respect to the template image for the large size ball, are compared to each other. If Cc is equal to or greater than Ca, a large ball is determined as being present. If Cc is less than Ca, an acceptable ball product is determined as being present. Thus, using a plurality of template images makes it possible to determine a slight difference in size, which cannot be made by using a single template.

In the above description, a method for inspecting a bump electrode has been explained in the case where the ball has not been heated to be soldered to a metal wiring portion on the substrate. If the ball is determined as being unacceptable, the ball can be replaced with a new one, e.g., by using tweezers or the like. The ball can then be inspected again to determine if the ball is acceptable. In the case of inspection where a ball has already been heated to be soldered to a metal wiring portion on the substrate, if the ball is determined as being unacceptable, it is necessary to replace the entire substrate.

In the present invention, parameters r and d for preparing the template image are adjustable parameters, which can be adjusted to obtain the highest determination performance by using a training image. Also, it is easy to quickly prepare the template image when the ball size to be inspected is changed.

As described above, gradation correction is performed by using a function having a saturation characteristic in the present invention. Accordingly, there is no risk that an acceptable product can be erroneously determined as a non-acceptable product even when the product to be inspected has a partially dark portion during pattern matching using a normalized correlation coefficient. Accordingly, this leads to an accurate inspection.

Also, since a mathematical formula model is used for preparing a template image, the preparation can be made very quickly. Furthermore, using a plurality of template images can provide an accurate determination of the size of a ball.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for inspecting a bump electrode comprising the steps of:
illuminating a substrate in an oblique direction where balls are arrayed by using an annular type illumination device;
photographing the substrate from above the substrate;
correcting a gradation of the photographed image of an annular pattern by using a function with a saturation characteristic;
making a segmented image which includes an image corresponding to at least one ball; and
determining whether each bump electrode is an acceptable product or not by pattern matching by calculating a normalized correlation coefficient between the segmented image and a template image prepared in advance.

2. The method according to claim 1, wherein the template image for pattern matching is prepared by using a mathematical formula model representing a luminance distribution.

3. The method according to claim 1, wherein said step of determining further includes the step of pattern matching by calculating a plurality of normalized correlation coefficients between the segmented image and a plurality of template images corresponding to sizes of a bump electrode to be inspected so that the size of the bump electrode can be determined.

4. The method according to claim 2, wherein said step of determining further includes the step of pattern matching by calculating a plurality of normalized correlation coefficients between the segmented image and a plurality of template images corresponding to sizes of a bump electrode to be inspected so that the size of the bump electrode can be determined.

5. The method according to claim 1, wherein the template image for pattern matching is prepared using the following formula representing a luminance distribution:
I(R, r, d)=255×exp{−(R−r/d)²},
where I is a luminance value of a template image; R is a distance from a center of the template image to an arbitrary point on the template image; r is a parameter for determining a radius of an annular pattern; and d is a parameter for determining a thickness of an annular pattern.

6. The method according to claim 1, wherein said function with a saturation characteristic used in said step of correcting a gradation of the photographed image is obtained from the following formula:
Iₒᵤₜ=255×(Iᵢₙ/255)^{γ},
where Iᵢₙ is the luminance value of the photographed image; Iₒᵤₜ is the luminance value after gradation correction; and γ is a parameter for adjusting the saturation characteristic.

7. The method according to claim 1, wherein said step of determining whether each bump electrode is an acceptable product or not includes the step of using a single template image corresponding to an acceptable product to calculate the normalized correlation coefficient.

8. The method according to claim 1, wherein said step of determining whether each bump electrode is an acceptable product or not includes the step of using a plurality of template images corresponding to at least a large size product, an acceptable size product and a small size product, respectively, to calculate a plurality of normalized correlation coefficients.

9. An apparatus for inspecting a bump electrode comprising:
an illumination device, said illumination device illuminating a substrate in an oblique direction where balls are arrayed;
an image pick-up device, said image pick-up device photographing the substrate from above the substrate;
an image processing device, said image processing device correcting a gradation of the photographed image of an annular pattern by using a function with a saturation characteristic, making a segmented image which includes an image corresponding to at least one ball and determining whether each bump electrode is an acceptable product or not by pattern matching by calculating a normalized correlation coefficient between the segmented image and a template image prepared in advance.

10. The apparatus according to claim 9, wherein the template image for pattern matching is prepared by using a mathematical formula model representing a luminance distribution.

11. The apparatus according to claim 9, wherein the pattern matching is performed by calculating a plurality of normalized correlation coefficients between the segmented image and a plurality of template images corresponding to sizes of a bump electrode to be inspected so that the size of the bump electrode can be determined.

12. The apparatus according to claim 10, wherein the pattern matching is performed by calculating a plurality of normalized correlation coefficients between the segmented image and a plurality of template images corresponding to sizes of a bump electrode to be inspected so that the size of the bump electrode can be determined.

13. The apparatus according to claim 9, wherein the template image for pattern matching is prepared using the following formula representing a luminance distribution:
I(R, r, d)=255×exp{−(R−r/d)²},
where I is a luminance value of a template image; R is a distance from a center of the template image to an arbitrary point on the template image; r is a parameter for determining a radius of an annular pattern; and d is a parameter for determining a thickness of an annular pattern.

14. The apparatus according to claim 9, wherein said function with a saturation characteristic for correcting a gradation of the photographed image is obtained from the following formula:
Iₒᵤₜ=255×(Iᵢₙ/255)^{γ},
where Iᵢₙ is the luminance value of the photographed image; Iₒᵤₜ is the luminance value after gradation correction; and γ is a parameter for adjusting the saturation characteristic.

15. The apparatus according to claim 9, wherein said image processing device determines whether each bump electrode is an acceptable product or not by using a single template image corresponding to an acceptable product to calculate the normalized correlation coefficient.

16. The apparatus according to claim 9, wherein said image processing device determines whether each bump electrode is an acceptable product or not by using a plurality of template images corresponding to at least a large size product, an acceptable size product and a small size product, respectively, to calculate a plurality of normalized correlation coefficients.
